(19) United States
(12) Patent Application Publication
(10) Pub. No.: US 2009/0182308 A1
(43) Pub. Date: Jul. 16, 2009

(54) Method and Device to Administer Medicine via a Pacifier

(76) Inventor: Idan Hagbi, Petach Tikva (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/353,927

(22) Filed: Jan. 14, 2009

Related U.S. Application Data
(60) Provisional application No. 61/011,204, filed on Jan. 16, 2008.

(51) Int. Cl. A61J 7/00; A61J 17/00

(52) U.S. Cl. 604/514; 606/236; 604/77

(57) ABSTRACT

Pacifier with a separable detachable device, a connection for injecting medicine from the rear side of the pacifier through a tube passing through the middle of the teat of the pacifier, directly into a child's mouth. When, the pacifier include the connectable part, which is the devise that enabling the medicine measurement or accommodation, and furthermore, has the ability to be connected and fit to the connection entrance of the tube, furthermore, enabling the injection of the medicine into the pacifier tube by pressure or air pressure, capping hermetically the entrance opening of the tubing will is connected to it.

### FIELD OF THE INVENTION

This invention is in the field of medicine applicators and in particular for administering medicines to babies and small children who can have the medicine injected into their mouths while they suck a pacifier.

### BACKGROUND OF THE INVENTION

It is well understood that designating pacifiers to direct medicine to baby's mouth is a well known publications both in patents and products fields.

However one skilled in the art knows well that the desire of those prior arts, are not sufficient to achieve the main goal by misleading and deception the baby's for there good propose of succeeding to deliver the essential medicine to the baby body.

It is the goal of this invention too to innovate a new and unique device and method that reveal another angle of approach and possibility to the same goal of easy entering medicine to the baby mouth, with minimum resistance. It is well known that most of the hard resistance is when the baby sees the parent for example approaching towards him with the medicine. It is most difficult in those situations to handling both the medicine not to be spilled toward the floor for example and at the same time to try to open the baby mouth at cetera.

This invention offering a deception that enabling operation in a few steps, first step is to fill the device with the medicine, secondly to connect the device to the back side of the pacifier, third to hold the pacifier from the device, device such as one that is like a syringe, as if honesty one is directing an ordinary pacifier to the baby mouth, and thirdly, when the pacifier is at the baby mouth from one side, immediately the parent for example pressing the device such as the syringe for example through the pacifier piping system through his mouth.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The object of this invention is to aid the administering of medicines to babies and small children using a pacifier. The pacifier is adapted to have at its rear portion a tube or an attachment point for a tube connector piece with an adaptor to fit a device like a syringe for example or similar to a syringe in its operational characters.

At the pacifier end of the tube, the tube would lead to the front portion of the pacifier inside the teat that is sucked by the child. The end of the tube would be coincident with the outer surface of the teat. Medicine that is injected with a syringe (without needing to attach a needle to the syringe) would pass through the tube and into the child's mouth. The tube would be optionally sealed after injecting the medicine, or at another embodiment of this invention the device can be part of the back side of the pacifier, connected to it. The rear portion of the teat and optionally the front side too, could be sealed to ensure that there would remain a vacuum effect when the child sucks on the teat and for hygienic reasons.

Alternatively, the tubing could lead to the end of the teat externally from the teat but adjacent to it and the child could suck the medicine out of the tube directly. There could be a cylinder covered by a contoured teat-like material so that the child is used to the shape and feel of the teat. When the medicine is to be applied the application tube could be pushed through the cylinder and after the medicine application the tube could be withdrawn without the child noticing any difference.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of the pacifier of this invention with the medicine tube passing through the teat.

FIG. 2 is a schematic depiction of the pacifier with an applicator device and piping for entering medicine external from the teat.

FIG. 3 is a schematic depiction of the cross section end view of the pacifier with the tube external to the teat.

FIG. 4 is a schematic depiction of the pacifier of this invention with detachable device with syringe characters and medicine tube passing through the teat.

FIG. 5 is a schematic depiction of the pacifier of this invention with detachable device with syringe characters and medicine tube passing through the teat.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

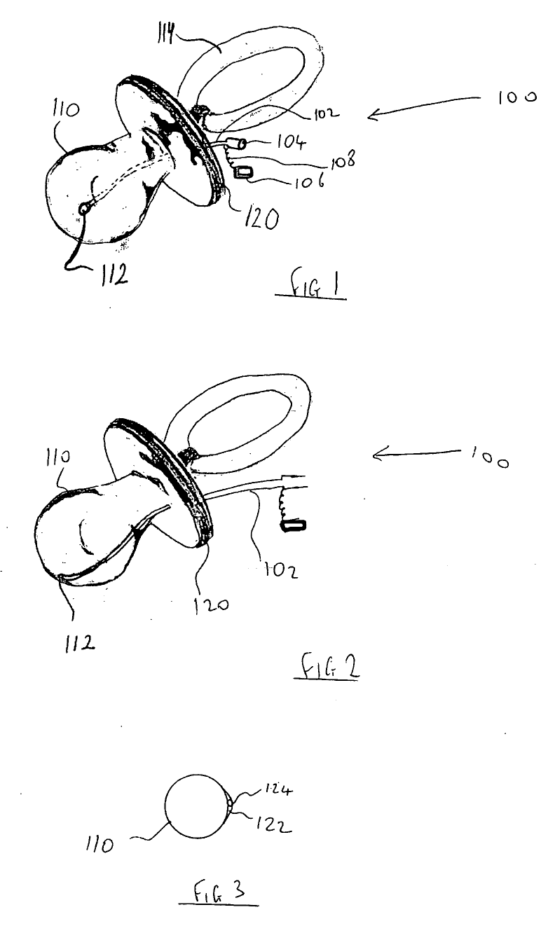

FIG. 1 shows a pacifier 100 with a tube 102 entering the pacifier 100 from the rear end of the pacifier 100. The entrance 104 to the tube 102 is a size to accommodate a syringe nozzle without a needle. The cap 106 is held by a chain 108 and the cap 106 covers the entrance 104 preferably hermetically in time when the syringe is not in an operation state.

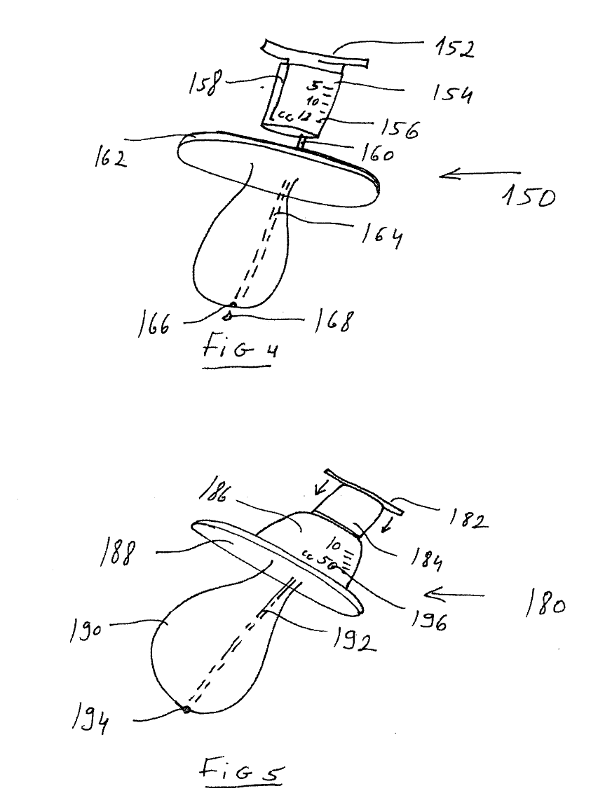

The tubing 102 passes through the pacifier shield 120 into the hollow of the teat 110 of the pacifier 100 and ends close to the rounded end of the teat 110 at the tube opening 112. Part 114 is not an essential part in this invention; on the contrary, in FIGS. 4 and 5 one skilled in the art can see depictions of the pacifier of the present inventions that part 114 is replaced by the syringe device itself for example as apart of the pacifier optionally at all time.

After the medicine has been injected into the tubing 102 the cap 106 would be left off until the child sucked out the medicine from the tube 102. Then the cap 106 would be placed on the entrance 104 in order to enable the child to suck to create a vacuum effect and for hygienic reasons. Alternatively, the quantity of medicine given to the child could be squirted into the child's mouth from the syringe via the tube 102. The diameter of the tube 102 would be sufficiently small so that the residual medicine would be insignificant. The child would not be required to suck out the medicine. The medicine would be inserted into the child's mouth while he sucks on the pacifier. The cap 106 would be replaced immediately after the insertion of the medicine in order to keep the time to a minimum, of the break in the vacuum created by the sucking effect on the pacifier.

FIG. 2 shows a pacifier 100 with a tube 102 the passes through the teat shield 120 remaining on and attached to the surface of the teat 110. In this embodiment the teat 110 would remain whole with the tube 102 attached to the external surface of the teat 110. The tube could be removed when not in use so the child could become used to the particular pacifier. When it is desired to administer medicine, the tube 102 could be attached to the teat 110. This attachment could be a smooth cylinder that forms part of the teat 110 into which the tube 102 could be passed.

FIG. 3 shows the cross sectional view of the teat 110 in the embodiment where it is possible to remove and replace the tube FIG. 2 102. There is a cylinder 124 covered in a contoured manner by a material 122 the same as or similar to the material of the teat 110. The tube FIG. 2 102 could be pushed through the cylinder 124 when desired to apply medicine.

FIG. 4 shows the pacifier 150 including two parts, the teat 164 and it base 162 and the syringe of this invention with detachable device with syringe 158 that connect to the base 162 at list with one connection for example 160 that at list one of the connecting means such as 160 is also functions as a medicine distributor 160 from the syringe 158 inner hollow container dedicated to accommodate the medicine, mainly a liquid medicine, through the piping means going through the treat 164 area. an air pressure or a pressure made by pushing part 152 into the syringe inner hollow container 154 enabling the flow of the measured medicine fitted to the desirable amount indicating one the syrien surface 156, to the teat piping 164 to the exit point 166 that enabling the medicine flow out 168.

FIG. 5 shows the pacifier 180 including one part, that part consist a few elements, the teat 190 and it base 188 and the syringe shaped here from container 186 and pushing part 184. a medicine distribution flows from the housing 186 part by the presser made by the user pushing part 184 from part 182 into the medicine housing part 186 the press pushes the medicine through the piping 192 crossing the teat 190 to the exit point 194.

an air pressure or a pressure made by pushing part 184 into the syringe inner hollow container 186 enabling the flow of the measured medicine fitted to the desirable amount indicating one the syrien surface 196.

What is claimed:

1. A Pacifier with a separable detachable device has a syringe characters connected to its rear side, designated for injecting medicine from the rear side of the pacifier by pushing the syringe handle into the syringe hollow container that housing the liquid medicine through a tube passing through the middle of the teat of the pacifier, directly into a child's mouth.

2. A Pacifier with a separable detachable device has a syringe characters connected to its rear side, designated for injecting medicine from the rear side of the pacifier by pushing the syringe handle into the syringe hollow container that housing the liquid medicine through a tube passing through the middle of the teat of the pacifier, directly into a child's mouth. The pacifier and device include:
At list two parts, the teat and it base of the pacifier and the hollow container of the syringe designated to housing liquid medicine and a handle fitted to the container opening to be pushed into the container to press the medicine ahead into the piping construction;
Whereby, inner hollow container dedicated to accommodate the medicine, mainly a liquid medicine, whereby, the teat and it base and the syringe of this with detachable device with syringe that connect to the base of the pacifier at list with one connection means which also functions as a medicine distributor from the syringe inner hollow container designated to accommodate the medicine, mainly a liquid medicine, through the piping means going through the treat area,
Whereby, air pressure or a pressure made by pushing part into the syringe inner hollow container enabling the flow of the measured medicine ahead.

3. A Pacifier as claimed in claims 2 wherein detachable device has syringe characteristics connects to the base of the pacifier at list with one connection means as it is also functions as a medicine distributor from the syringe to the pacifier teat and to the child mouth.

4. A Pacifier as claimed in claims 2 wherein the syringe is part of the pacifier base back side.

5. A method for deliver in liquid and liquid medicine by pacifier to chilled and baby's, pacifier with a separable detachable device, dedicated for injecting medicine from the device located at the rear side of the pacifier through a tube passing through the middle of the teat of the pacifier, directly into a child's mouth.
The method comprising the following steps:
Prior of helping the child or to the baby and serving the pacifier to his mouth, the pacifier is filled with the right amount of liquid into the hollow part located at the back side of the pacifier; and
The opening of the hollow container functioning as the liquids housing part of syringe is sealed, similar to the closing and sealing of syringe by its handle, yet enabling the handle to slide into inner part of the hollow container; and
to hold the pacifier from the handle of the syringe device, as if honesty one is directing an ordinary pacifier to the baby mouth, and, when the pacifier is at the baby's mouth from one side, immediately to push the device handle into the liquid container pushing the liquids ahead through the pacifier piping system through the baby's mouth.

6. A method as claimed in claims 5 wherein the syringe is part of the pacifier base back side.

7. A method as claimed in claims 5 wherein the pushing handle is replaced by an air pressure.
